(19) United States
(12) Patent Application Publication
(10) Pub. No.: US 2026/0293852 A1
(43) Pub. Date: Oct. 1, 2026

(54) ANIMAL WASTE BAG DEVICE

(71) Applicants: Jacquette Maynard, Ventura, CA (US); Tyrone Maynard, Ventura, CA (US)

(72) Inventors: Jacquette Maynard, Ventura, CA (US); Tyrone Maynard, Ventura, CA (US)

(21) Appl. No.: 19/574,851

(22) Filed: Mar. 23, 2026

Related U.S. Application Data
(60) Provisional application No. 63/777,197, filed on Mar. 25, 2025.

(51) Int. Cl. A01K 23/00

(52) U.S. Cl. CPC A01K 23/005

(57) ABSTRACT

An animal waste bag device is provided. The device is comprised of a waste bag with at least one moistened, disinfecting wipe stored within the interior space of the bag. The wipe may be stored within an internal, sealed housing to preserve moistness in one embodiment. In another embodiment, the wipe is comprised of a disintegrable film that seals the moistness of the wipe until the wipe is used to clean/clean up after an animal.

### CROSS-REFERENCE TO RELATED APPLICATION

The present application claims priority to, and the benefit of, U.S. Provisional Application No. 63/777,197, which was filed on Mar. 25, 2025, and is incorporated herein by reference in its entirety.

### FIELD OF THE INVENTION

The present invention relates generally to the field of animal waste bags. More specifically, the present invention relates to an animal waste bag device comprised of an internal, sealed, wet wipe. Accordingly, the present disclosure makes specific reference thereto. Nonetheless, it is to be appreciated that aspects of the present invention are also equally applicable to other like applications, devices, and methods of manufacture.

### BACKGROUND

Many pet owners clean up their pet's waste with a waste bag. However, said pet owners are unable to easily clean vomit or any fecal matter that may be stuck to the pet after defecating. As a result, if they wish to have this ability, they must travel with a container of wipes in addition to animal waste bags. This is undesirable as it increases the number of items a pet owner must take on a walk, run, etc.

Therefore, there exists a long-felt need in the art for an improved animal waste bag. There also exists a long-felt need in the art for an animal waste bag device that does not require that a pet owner separately carry wet wipes and animal waste bags. More specifically, there exists a long-felt need in the art for an animal waste bag device that provides a combination animal waste bag and wet wipe.

The subject matter disclosed and claimed herein, in one embodiment thereof, comprises an animal waste bag device. The device is comprised of a waste bag with at least one wipe stored within the interior space of the bag. The wipe is preferably any type of pre-moistened, disinfecting wipe known in the art. The wipe may be stored within an internal, sealed housing to preserve moistness in one embodiment. In another embodiment, the wipe is comprised of a disintegrable film that seals the moistness of the wipe until the wipe is used to clean/clean up after an animal.

In this manner, the animal waste bag device of the present invention accomplishes all the foregoing objectives and provides an improved animal waste bag. More specifically, the device provides an animal waste bag that does not require that a pet owner separately carry wet wipes and animal waste bags. Instead, the device provides a wet wipe stored within an animal waste bag.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal waste bag device. The device is comprised of a waste bag with at least one wipe stored within the interior space of the bag. The bag is preferably made from a plastic waste bag material such as, but not limited to, film, high-density polyethylene, low-density polyethylene, linear low-density polyethylene, etc.

In one embodiment, the bag is a continuous bag shape with one opening that allows animal waste to be inserted into the interior space during use of the device. The interior space is also comprised of at least one wipe. The wipe is preferably a wet wipe or other saturated, moistened, disinfecting wipe known in the art such as, but not limited to, a polyester wipe, a polypropylene wipe, a cotton wipe, a wood pulp wipe, a rayon fiber wipe, etc.

In one embodiment, the wipe is encapsulated in a disintegrable film. The film keeps the wipe moist until the wipe is used to clean the body of an animal after the animal has defecated. At this point, the film degrades in the process of being used (i.e., contacting the animal's body).

In another embodiment, the wipe is stored within at least one flexible housing within the interior space. The wipe can be accessed by removing at least one adhesive seal from the housing to allow the wipe to be pulled from an opening of the housing positioned below the seal. In this manner, the seal ensures moisture is retained within the housing to keep the wipe moist until use.

The present invention is also comprised of a first method of using the device. First, a device is provided comprised of a bag with an interior space with at least one wipe covered in at least one film. Then, a user can remove the wipe from the interior space and use the wipe as needed to clean the body of an animal, animal vomit, animal waste, etc. Next, a user can use the bag to collect animal waste and place the waste in the interior space. Finally, a user can discard the wipe into the interior space and then discard the device.

A second method of using the device involves providing a device comprised of a bag with an interior space with at least one wipe. In this embodiment, the wipe is stored within at least one housing within the interior space. Then, a user can remove the wipe from the housing by removing the adhesive seal and pulling the wipe from the housing via an opening. Next, a user can use the wipe as needed to clean the body of an animal, animal vomit, animal waste, etc. Then, a user can use the bag to collect animal waste and place the waste in the interior space. Finally, a user can discard the wipe into the interior space and then discard the device.

Accordingly, the animal waste bag device of the present invention is particularly advantageous as it provides an improved animal waste bag. During use, the device does not require that a pet owner separately carry wet wipes and animal waste bags. In this manner, the animal waste bag device overcomes the limitations of existing animal waste bags known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters. refer to similar parts throughout the different views, and in which:

FIG. 1 illustrates a side perspective view of one potential embodiment of an animal waste bag device of the present invention in accordance with the disclosed architecture;

FIG. 2 illustrates a side perspective view of one potential embodiment of an animal waste bag device of the present invention in accordance with the disclosed architecture;

FIG. 3 illustrates a flowchart of a method of using one potential embodiment of an animal waste bag device of the present invention in accordance with the disclosed architecture; and

FIG. 4 illustrates a flowchart of a method of using one potential embodiment of an animal waste bag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved animal waste bag. There also exists a long-felt need in the art for an animal waste bag device that does not require that a pet owner separately carry wet wipes and animal waste bags. More specifically, there exists a long-felt need in the art for an animal waste bag device that provides a combination animal waste bag and wet wipe.

The present invention, in one exemplary embodiment, is comprised of an animal waste bag device. The device is comprised of a waste bag with at least one wipe stored within the interior space of the bag. The bag is preferably made from a plastic waste bag material such as, but not limited to, film, high-density polyethylene, low-density polyethylene, linear low-density polyethylene, etc.

The bag may be a continuous bag shape with one opening that allows animal waste to be inserted into the interior space during use of the device. The interior space is also preferably comprised of at least one wipe which is preferably a wet-wipe or other saturated, moistened, disinfecting wipe known in the art such as, but not limited to, a polyester wipe, a polypropylene wipe, a cotton wipe, a wood pulp wipe, a rayon fiber wipe, etc. In one embodiment, the wipe is encapsulated in a disintegrable film to keep the wipe moist until the wipe is used to clean the body of an animal after the animal has defecated. At this point, the film degrades in the process of being used (i.e., contacting the animal's body). In another embodiment, the wipe is stored within at least one flexible housing within the interior space. The wipe can be accessed by removing at least one adhesive seal from the housing to allow the wipe to be pulled from an opening of the housing positioned below the seal. In this manner, the seal ensures moisture is retained within the housing to keep the wipe moist until use.

The present invention is also comprised of a first method of using the device. First, a device is provided comprised of a bag with an interior space with at least one wipe covered in at least one film. Then, a user can remove the wipe from the interior space and use the wipe as needed to clean the body of an animal, animal vomit, animal waste, etc. Next, a user can use the bag to collect animal waste and place the waste in the interior space. Finally, a user can discard the wipe into the interior space and then discard the device.

A second method of using the device involves providing a device comprised of a bag with an interior space with at least one wipe. In this embodiment, the wipe is stored within at least one housing within the interior space. Then, a user can remove the wipe from the housing by removing the adhesive seal and pulling the wipe from the housing via an opening. Next, a user can use the wipe as needed to clean the body of an animal, animal vomit, animal waste, etc. Then, a user can use the bag to collect animal waste and place the waste in the interior space. Finally, a user can discard the wipe into the interior space and then discard the device.

Accordingly, the animal waste bag device of the present invention is particularly advantageous as it provides an improved animal waste bag. During use, the device does not require that a pet owner separately carry wet wipes and animal waste bags. In this manner, the animal waste bag device overcomes the limitations of existing animal waste bags known in the art.

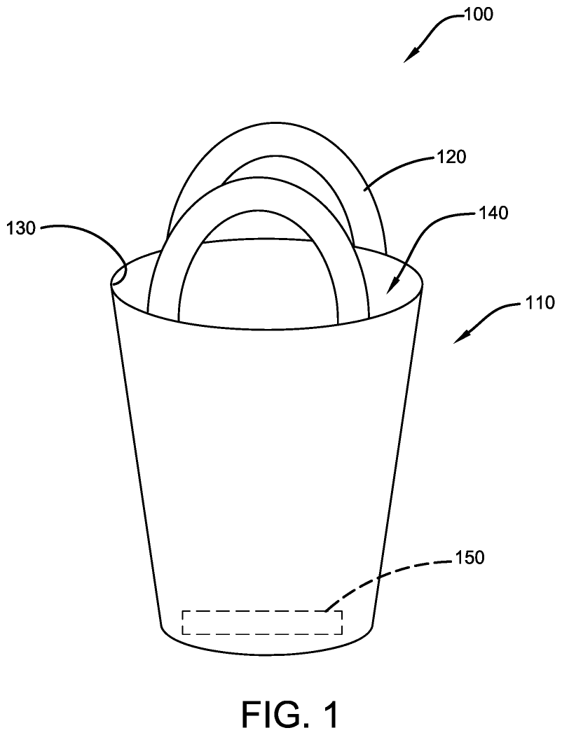

Referring initially to the drawings, FIG. 1 illustrates a side perspective view of one potential embodiment of an animal waste bag device 100 of the present invention in accordance with the disclosed architecture. The device 100 is comprised of a waste bag 110 with at least one wipe 150 stored within the interior space 140 of the bag 110. The bag 110 is preferably made from a plastic waste bag material such as, but not limited to, film, high-density polyethylene, low-density polyethylene, linear low-density polyethylene, etc. Said material may be a recycled material in one embodiment. In another embodiment, the material is biodegradable such as, but not limited to, paper, organic material, polycaprolactone, hemp, etc. The bag 110 may be any size in different embodiments.

In one embodiment, the bag 110 is a continuous bag shape with one opening 130. The opening 130 allows animal waste to be inserted into the interior space 140 during use of the device 100. In one embodiment, the bag 110 is comprised of at least one handle 120 (but preferably two handles 120) that allows a user to easily hold and/or tie the bag after the animal waste has been inserted into the bag 110.

The interior space 140 is also comprised of at least one wipe 150. The wipe 150 is preferably a wet-wipe or other saturated, moistened, disinfecting wipe known in the art such as, but not limited to, a polyester wipe, a polypropylene wipe, a cotton wipe, a wood pulp wipe, a rayon fiber wipe, etc. The wipe 150 may be scented or unscented with any natural or synthetic scent. In one embodiment, the wipe 150 is encapsulated in a disintegrable film 152 that keeps the wipe 150 moist until the wipe 150 is used to clean the body of an animal after the animal has defecated, wherein the film 152 degrades in the process of being used (i.e., contacting the animal's body).

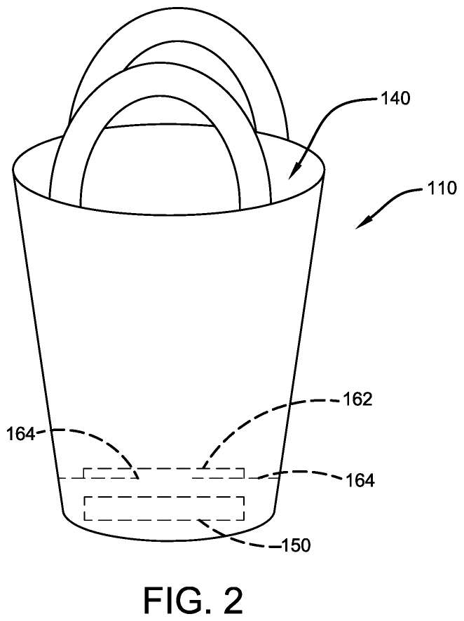

In another embodiment, the wipe 150 is stored within at least one flexible housing 160 within the interior space 140, as seen in FIG. 2. The housing 160 may be made from the same material as the bag 110 and/or a thin film. The wipe 150 can be accessed by removing at least one adhesive seal 162 from the housing 160 to allow the wipe 150 to be pulled from an opening 164 of the housing 160 positioned below the seal 162. In this manner, the seal 162 ensures moisture is retained within the housing 160 to keep the wipe 150 moist until use.

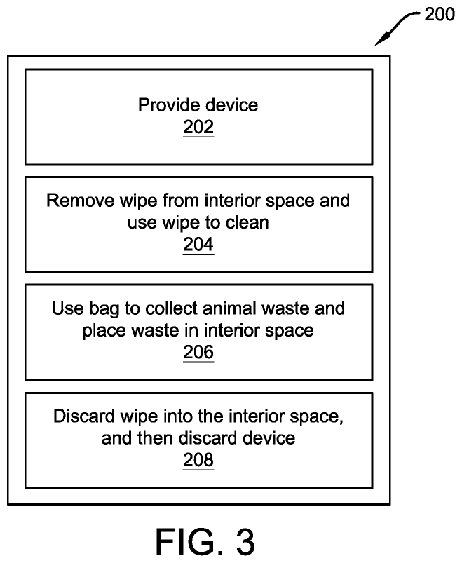

The present invention is also comprised of a first method of using 200 the device 100, as seen in FIG. 3. First, a device 100 is provided comprised of a bag 110 with an interior space 140 with at least one wipe 150 covered in at least one film 152 [Step 202]. Then, a user can remove the wipe 150 from the interior space 140 and use the wipe 150 as needed to clean the body of an animal, animal vomit, animal waste, etc. [Step 204]. Next, a user may use the bag 110 to collect animal waste and place the waste in the interior space 140 [Step 206]. Finally, a user can discard the wipe 150 into the interior space 140 and then discard the device 100 [Step 208].

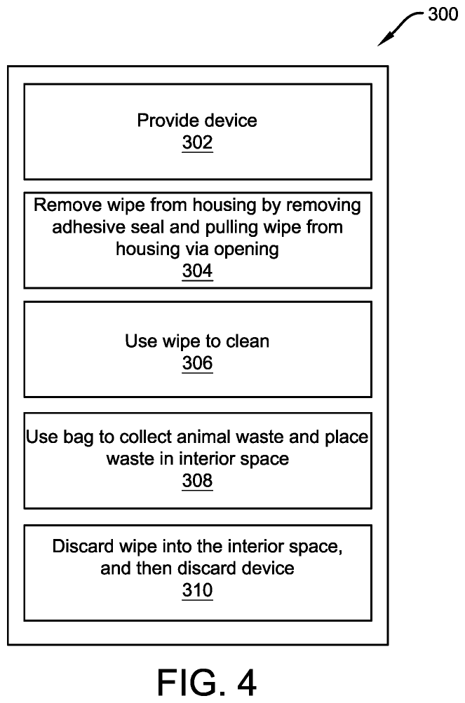

The present invention is also comprised of a second method of using 300 the device 100, as seen in FIG. 4. First, device 100 is comprised of a bag 110 with an interior space 140 with at least one wipe 150 stored within at least one housing 160 within the interior space 140 [Step 302]. Then, a user can remove the wipe 150 from the housing 160 by removing the adhesive seal 162 and pulling the wipe 150 from the housing 160 via an opening 164 [Step 304]. Then, a user can use the wipe 150 as needed to clean the body of an animal, animal vomit, animal waste, etc. [Step 306]. Next, a user may use the bag 110 to collect animal waste and place the waste in the interior space 140 [Step 308]. Finally, a user can discard the wipe 150 into the interior space 140 and then discard the device 100 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “animal waste bag device” and “device” are interchangeable and refer to the animal waste bag device 100 of the present invention.

Notwithstanding the foregoing, the animal waste bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal waste bag device 100 as shown in the FIGS. are for illustrative purposes only, and that many other sizes and shapes of the animal waste bag device 100 are well within the scope of the present disclosure. Although the dimensions of the animal waste bag device 100 are important design parameters for user convenience, the animal waste bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal waste bag device comprising:
a bag comprised of an opening and an interior space; and
a moistened wipe comprised of a film positioned within the interior space.

2. The animal waste bag device of claim 1, wherein the bag is comprised of a biodegradable material.

3. The animal waste bag device of claim 1, wherein the bag is comprised of a handle.

4. The animal waste bag device of claim 1, wherein the bag is comprised of a recycled material.

5. The animal waste bag device of claim 1, wherein the bag is comprised of a plastic material.

6. The animal waste bag device of claim 1, wherein the film is comprised of a disintegrating film.

7. The animal waste bag device of claim 1, wherein the moistened wipe is comprised of a scented wipe.

8. An animal waste bag device comprising:
a bag comprised of an opening and an interior space;
a housing comprised of an adhesive seal and an opening, the housing positioned in the interior space; and
a moistened wipe.

9. The animal waste bag device of claim 8, wherein the moistened wipe is positioned within the housing.

10. The animal waste bag device of claim 8, wherein the adhesive seal is positioned over the opening.

11. The animal waste bag device of claim 8, wherein the housing is comprised of a film.

12. The animal waste bag device of claim 8, wherein the moistened wipe is comprised of a polyester wipe, a polypropylene wipe, a cotton wipe, a wood pulp wipe, or a rayon fiber wipe.

13. The animal waste bag device of claim 8, wherein the bag is comprised of a biodegradable material.

14. The animal waste bag device of claim 8, wherein the bag is comprised of a handle.

15. The animal waste bag device of claim 8, wherein the bag is comprised of a recycled material.

16. The animal waste bag device of claim 8, wherein the bag is comprised of a plastic material.

17. The animal waste bag device of claim 8, wherein the moistened wipe is comprised of a scented wipe.

18. A method of using an animal waste bag device, the method comprising the following steps:
providing an animal waste bag device comprised of a bag comprised of an interior space and comprised of a wipe positioned within the interior space;
removing the wipe from the interior space;
using the wipe; and
discarding the wipe into the interior space.

19. The method of claim 18 further comprised of a step of using the wipe to wipe a body of an animal.

20. The method of claim 18 comprised of a step of using the bag to collect an animal feces.
